(19) United States
(12) Patent Application Publication
(10) Pub. No.: US 2007/0272718 A1
(43) Pub. Date: Nov. 29, 2007

(54) Note Pad Device

(76) Inventor: Frances Todd Stewart, Pittsburgh, PA (US)

Correspondence Address: ANDREW J. CORNELIUS;ANDREW J. CORNELIUS, P.C., SUITE 205, 305 MT. LEBANON BOULEVARD, PITTSBURGH, PA, 15234, US

(21) Appl. No.: 10/584,787

(22) PCT Filed: Dec. 30, 2004
(86) PCT No.: PCT/US04/43985

§ 371 Date: Jun. 7, 2007

Related U.S. Application Data
(60) Provisional application No. 60/533,685, filed on Dec. 31, 2003.

(51) Int. Cl. B60R 7/05

(52) U.S. Cl. 224/312

(57) ABSTRACT

A note pad holder (10) provides the occupant of a vehicle a safe and convenient way to position a note pad (12) in the vehicle. The note pad holder includes a clip (18) for removably retaining the note pad holder on the visor of a vehicle, a base for supporting a note pad while notes are being taken on the note pad, a pair of clips (42, 52) for removably holding the pad against the base and a pair of curved grips (32) for removably holding a writing instrument on the note pad holder.

### CROSS REFERENCE TO RELATED APPLICATIONS

This application claims the benefit of copending U.S. Provisional Application No. 60/533,685, filed Dec. 31, 2003, by the same inventor.

### BACKGROUND OF THE INVENTION

The present invention pertains to note pads and, more particularly, to a note pad that can be used in a vehicle.

It is often necessary or desirable to have a consistent and convenient place to take notes in an automobile or other vehicle. Just as refrigerator note pads have served a purpose for handy note taking and collection, it is also useful to provide a way to place a note pad within an automobile or other vehicle. It is known to mount notepads to the automobile dashboard or windshield, but these devices may represent a hazard to occupants of a vehicle if they are struck by them during a collision. Also, these devices can obstruct the driver's view when they are attached to the automobile windshield and, therefore, they represent a safety hazard.

There is, therefore, a need for a device that provides an occupant of an automobile or other vehicle a safe and convenient system for storing a note pad while in the vehicle.

### SUMMARY OF THE INVENTION

The present invention provides a convenient and safe way to attach a note pad to the visor of an automobile or other vehicle. The preferred embodiment of the present invention is a note pad holder having a clip mechanism that is designed to be placed on the visor. The note pad holder includes a base for supporting a note pad while notes are being taken on the note pad, a pad holder for removably holding the pad against the base, a writing instrument holder for removably holding a writing instrument on the note pad holder, and a retainer for removably retaining the note pad holder on the visor of a vehicle when the holder is hanging upside down from the visor. Preferably, the pad holder is a pair of clips, one clip being a spring loaded clip that is biased to force one end of the note pad against the base, and a base retaining clip that defines a cradle that maintains the remaining end of the note pad in place against the base. The base retaining clip secures the base of the pad in a way that allows paper to be easily removed from the pad without interference, but also holds the pad in place when the pad is hanging upside down on the visor. Also preferably, the instrument holder includes a pair of curved, flexible grips that can be forced apart to cradle an instrument between the grips and removably hold the instrument on the note pad holder. Thus, the note pad holder can be repeatedly mounted on and removed from the visor of the vehicle, and the writing instrument and note pad can be placed on and removed from the note pad holder.

The present invention also provides a note pad device that permits the occupant of an automobile or other vehicle to store notes in the car conveniently and safely on the car visor. The note pad device includes a note pad, a base for supporting the note pad while notes are being taken on the note pad, a writing instrument for taking notes on the note pad, a pad holder for removably holding the note pad against the base, a writing instrument holder for removably holding the writing instrument on the note pad holder, and a retainer for removably retaining the note pad holder on the visor of an automobile or other vehicle. Preferably, the pad holder is a pair of clips, one clip being spring loaded and biased to force one end of the note pad against the base, and the remaining clip defining a cradle that maintains the remaining end of the note pad in place against the base. Also preferably, the instrument holder includes a pair of curved, flexible grips that can be forced apart to cradle the instrument between the grips and removably hold the instrument on the note pad holder. If desired, the sheets of the note pad can include artwork. Thus, the note pad device can be repeatedly mounted on and removed from the visor of the vehicle, and the writing instrument and note pad can be placed on and removed from the note pad device.

### BRIEF DESCRIPTION OF THE DRAWINGS

The following detailed description of the preferred embodiment may be understood better if reference is made to the appended drawing, in which:

FIG. 1 is a perspective view of a note pad holder removably mounted to the front edge of the visor of an automobile and positioned upside down on the bottom of the visor;

FIG. 2 is a top plan view of the note pad holder shown in FIG. 1;

FIG. 3 is a bottom plan view of the note pad holder shown in FIG. 1;

FIG. 4 is a left side view of the note pad holder shown in FIG. 1;

FIG. 5 is a right side view of the note pad holder shown in FIG. 1;

FIG. 6 is a top end view of the note pad holder shown in FIG. 1; and

FIG. 7 is a bottom end view of the note pad holder shown in FIG. 1;

FIG. 8A is a perspective view of part of the holder shown in FIG. 1, which shows the tension holder of the holder;

FIG. 8B is a sectional view of the tension holder shown in FIG. 8A, taken along the line 8B-8B;

FIG. 8C is a sectional view of an alternate tension holder;

FIGS. 9A and 9B are perspective views of a note pad holder removably mounted to the side edge of the visor of an automobile and positioned upside down on the bottom of the visor; and

FIGS. 10A, 10B, 10C and 10D are perspective views of a note pad holder removably mounted to the front edge of the visor of an automobile and positioned on the top of the visor.

### DETAILED DESCRIPTION OF THE PREFERRED EMBODIMENTS

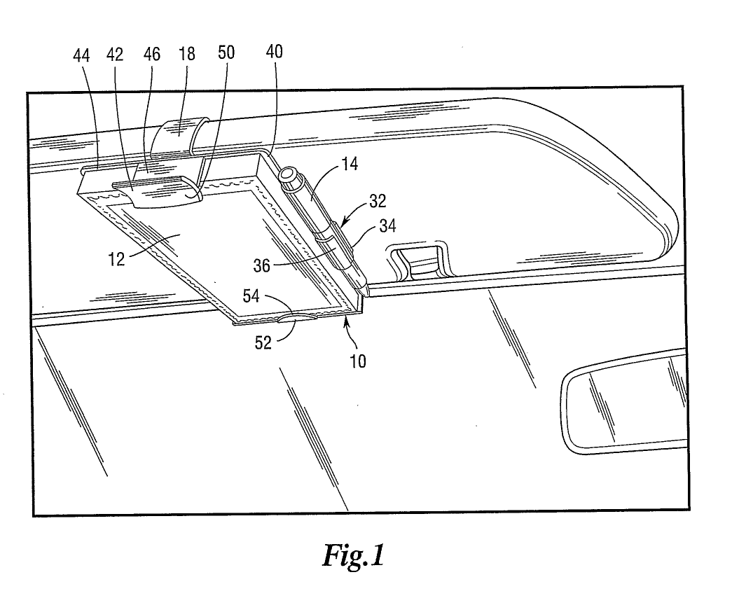

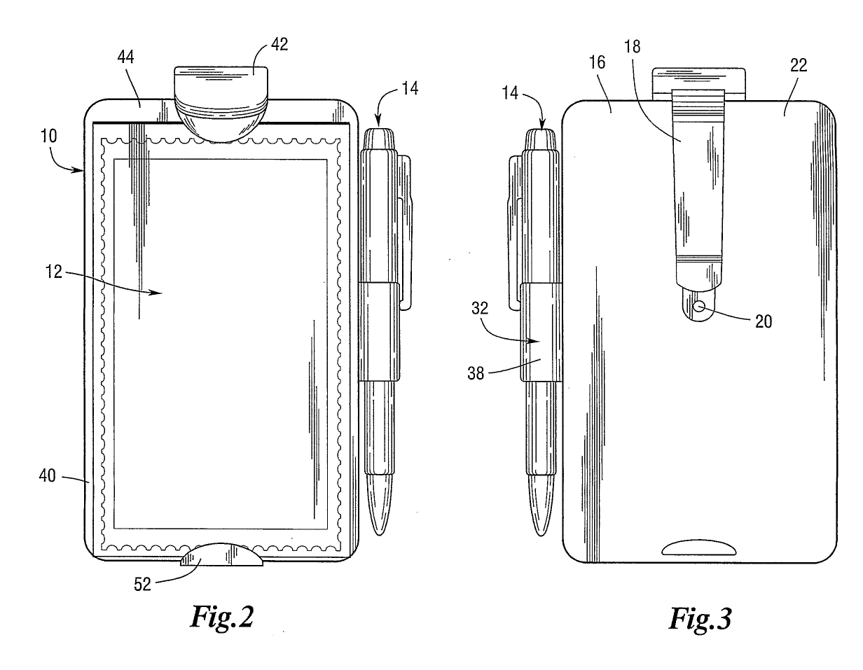

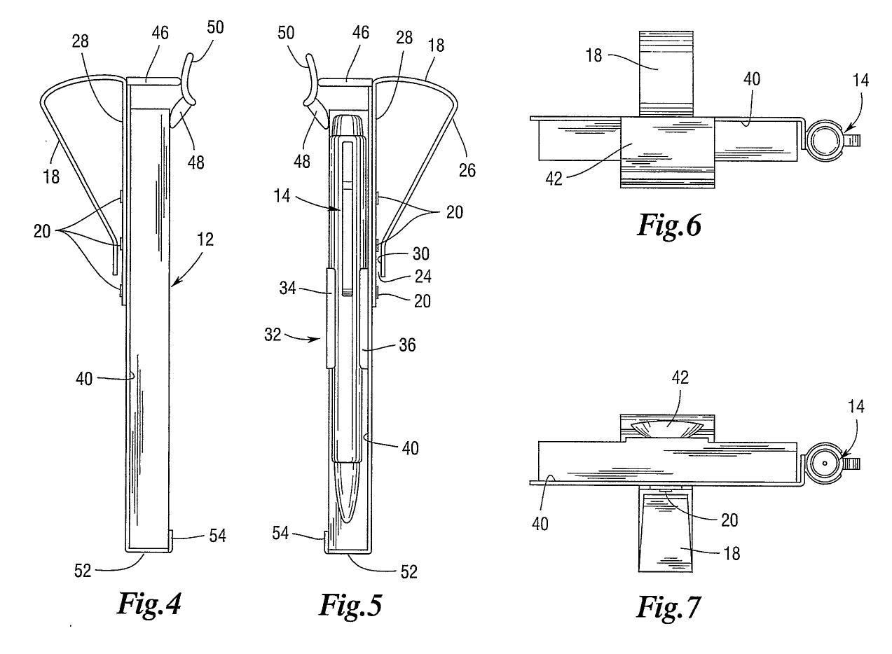

The figures show a notepad holder 10 that is the preferred embodiment of the present invention. FIG. 1 shows holder 10 mounted to the lower surface of an automobile visor using a metal clip 18 that is attached to the front edge of the visor of an automobile. Holder 10 holds a notepad 12 and a writing instrument 14. Writing instrument 14 can be any suitable instrument that can be used to take notes on paper but is, preferably, an instrument, like a pencil, that can make a mark on paper regardless of the orientation of instrument 14. Therefore, the instrument can be used by an occupant to write continuously on a pad that is mounted above the occupant. Preferably, the pages of the notepad are decorated with a suitable design.

Holder 10 can be repeatedly mounted to and removed from the visor of an automobile to allow an occupant of the automobile to take notes in the automobile. Holder 10 can be used to take notes either while holder 10 is mounted to the visor, or after holder 10 has been removed from the visor. Because holder 10 is mounted to the visor, it is mounted at a safe distance and location relative to the occupants of the automobile. Thus, it is not likely that holder 10 will come into contact with an occupant during a collision. Also, due to the size and design of holder 10, holder 10 does not protrude from the visor in a way that will obstruct the driver's view when it is mounted to the visor. Holder 10 can be mounted to either the upper surface or the bottom surface of the visor. If desired, holder 10 can be nearly completely concealed from view when the visor is in its stored position by mounting holder 10 on the upper surface of the visor. When holder 10 is mounted to the upper surface of the visor, the notes recorded on pad 12 are hidden when the visor is not in use as a sunshield. Thus, mounting holder 10 to the upper surface of the visor provides more confidentiality by concealing the information recorded on note pad 12.

Holder 10 is constructed of a suitable plastic material such as ABS grade plastic that can withstand the extremes of temperatures sometimes present in the interior of an automobile, notably temperatures of up to 100 F. Preferably, the overall dimensions of holder 10 are 5 5/16″ long by 3 5/16″ wide. However, these dimensions can be increased in the event larger visors come into use. Also preferably, the overall length of holder 10 should not exceed 5¾″ to permit the automobile visor to be placed in its “up” or retracted position on the top surface of the visor, that is the surface that confronts the roof of the automobile when the visor is raised, to allow for confidentiality of the notes taken on pad 12 when the visor is not being used as a sunshield in its lower position. Holder 10 defines a main board 16, to the rear surface 22 of which a spring-biased metal clip 18 is fastened using three suitable fasteners, such as rivets 20. Clip 18 is used to removably mount holder 10 to the automobile visor. That is, clip 18 can be clipped onto and removed from the visor to allow holder 10 to be mounted to and detached from the visor. Preferably, clip 18 is made of steel sheet and is ½″ wide by 2½″ long. Clip 18 defines an opening 24 through which the visor passes as holder 10 is being mounted to the visor. The configuration of clip 18 causes member 26 to be biased to a position in which bearing surface 30 of member 26 is 13/16″ from member 28 of clip 18 to create an opening that is 13/16″ wide. The size of opening 24 allows clip 18 to accommodate visors having a thickness that falls within a wide range, yet permits bearing surface 30 to exert sufficient pressure on a visor between surface 30 and member 28 of clip 18 to maintain holder 10 in place on the visor during use.

Holder 10 defines a tension holder 32 for a writing instrument 14 that holds instrument 14 in place when instrument 14 is not in use, but allows for easy access to instrument 14 when a user decides to take notes using instrument 14. Holder 32 defines a pair of grips 34 and 36 between which instrument 14 is removably held. Each of grips 34 and 36 defines a curved surface that is intended generally to match the curvature of instrument 14 located between grips 34 and 36. When instrument 14 is forced between grips 34 and 36, the elasticity of grips 34 and 36 permits them to deform to spread apart and accept instrument 14. Additional protrusions 60 can be provided at the top and bottom of tension holder 32 to hold instrument 14 in place. Tension holder 32 allows instrument 14 to be attached to and removed from holder 10. As instrument 14 is pushed against the base 38 of holder 32, grips 34 and 36 move to assume their original positions, in which they cradle instrument 14 and prevent it from becoming detached from grip 32 until the user reverses this process to remove instrument from holder 32.

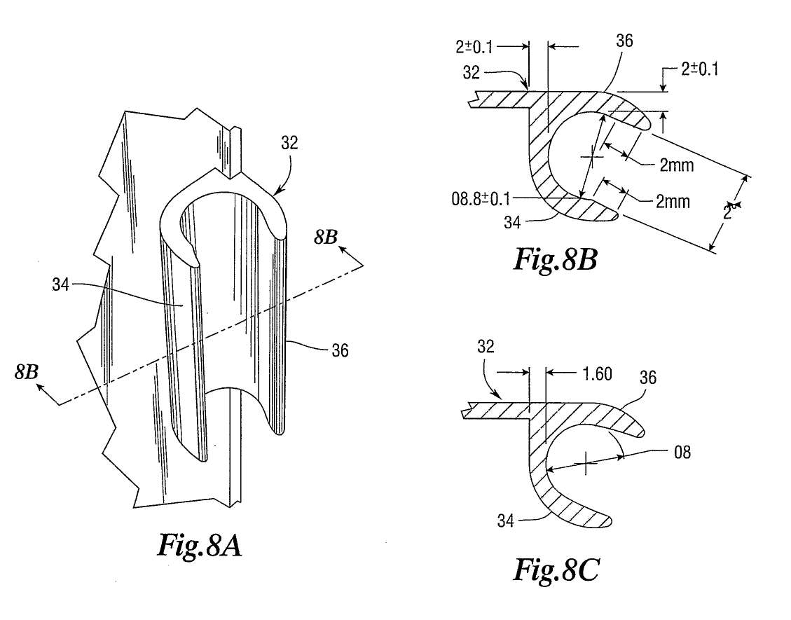

FIG. 8 shows additional detail for tension holder 32. Preferably, tension holder 32 is constructed of ABS plastic, Chi Mei, Polylac Grade PA-757 (black), or Polylac Grade PA 758 (clear). FIGS. 8B and C show the preferable dimensions for tension holder 32, with the tension holder shown in FIG. 8B having the preferred dimensions. All dimensions are in millimeters.

Holder 10 also defines a writing surface 40 that supports notepad when the user is writing on it. A spring loaded notepad clip 42 projects from a support 46 defined by one end 44 of surface 40. Clip 42 defines a projection 48 that is spring loaded to force pad 12 against surface 40. Clip 42 also defines an operator 50 that the user can operate with their thumb to rotate clip 42 and projection 48 away from pad 12 against the force of the spring to release pad 12 from surface 40 when the user wishes to remove pad 12 from holder 10. Holder 10 defines a bottom support or clip 52 having a lip 54 that forms a cradle that holds the bottom of pad 12 in place against surface 40. Clips 42 and 52 cooperate to hold pad 12 in place on surface 40, and also permit individual sheets to be removed from pad 12 during use. Preferably, pad 12 is 4¾″ high by 2¾″ wide, which permits sliding pad 12 in place between clips 42 and 52 and surface 40. The sheets of pad 12 can be printed with artwork intended to appeal to the user of holder 10.

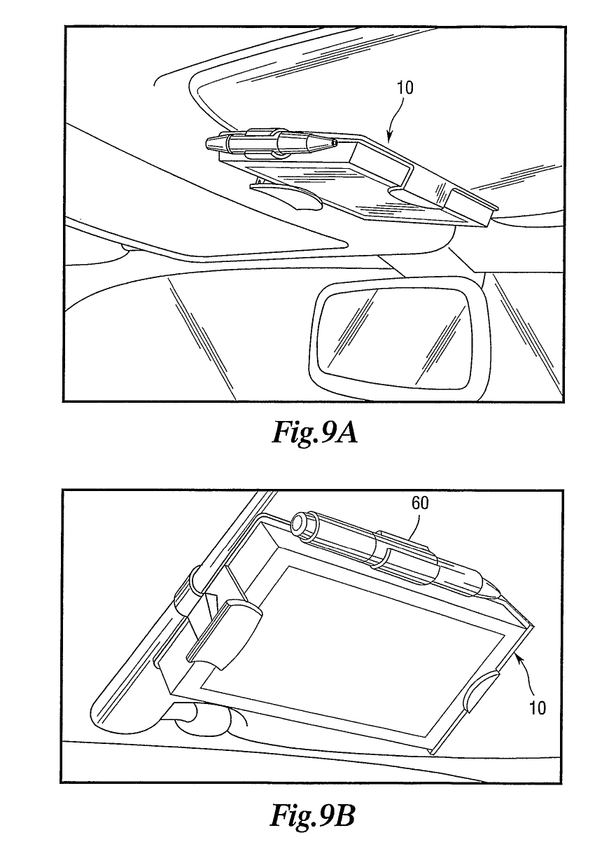

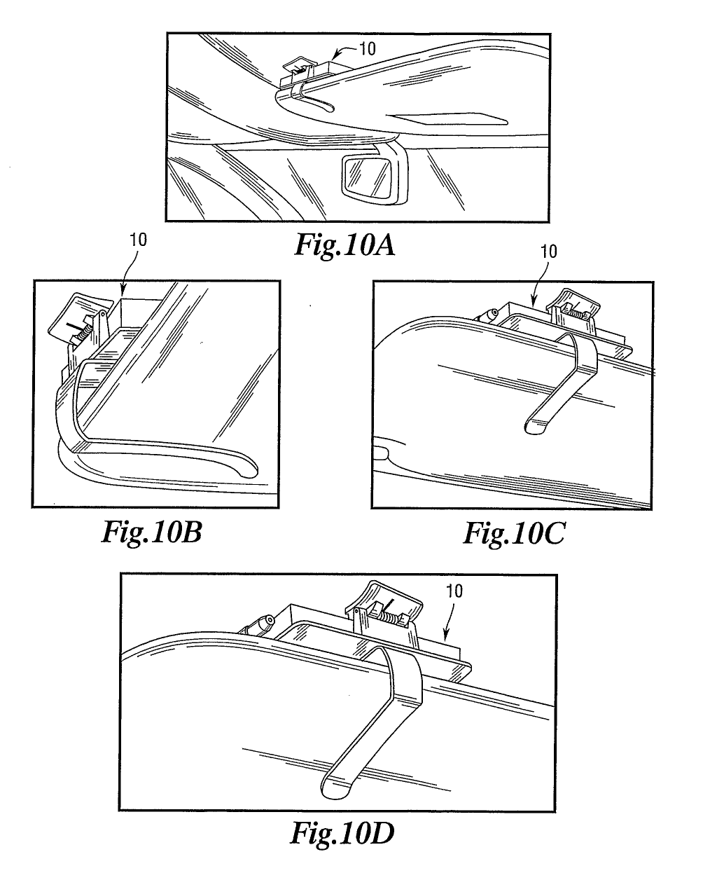

FIGS. 9 and 10 show alternate ways of mounting holder 10 to the visor. FIGS. 9A and 9B show holder 10 mounted to the lower surface of the visor by the side edge of the visor. FIGS. 10A, 10B, 10C and 10D show holder 10 mounted to the upper surface of the visor by the front edge of the visor.

It should be understood that, while the preferred embodiment of the present invention is shown in the figures mounted to the visor of an automobile, the present invention can be used with any type of vehicle that has a visor or similar part.

What is claimed is:

1. A note pad holder that provides the occupant of a vehicle with a convenient and safe way of mounting a note pad in a vehicle comprising:
a retainer for removably retaining a note pad holder on the visor of the vehicle;
a base for supporting the note pad while notes are being taken on the note pad;
a pad holder for removably holding the pad against said base; and
a writing instrument holder for removably holding a writing instrument on said note pad holder.

2. The note pad holder recited by claim 1 wherein said pad holder is a pair of clips, one said clip being spring loaded and being biased to force one end of the note pad against said base, and the remaining said clip defining a cradle that maintains the remaining end of the note pad in place against said base.

3. The note pad holder recited by claim 1 wherein said instrument holder includes a pair of curved, flexible grips that can be forced apart to hold an instrument between said grips and allow for the removal of the instrument from said grips to remove the instrument from said note pad holder.

4. A note pad device that permits the occupant of a vehicle to mount a note pad in a convenient and safe place in a vehicle comprising:
a retainer for removably retaining said note pad device on the visor of a vehicle;
a note pad;
a base for supporting said note pad while notes are being taken on said note pad;
a writing instrument for taking notes on said note pad;
a pad holder for removably holding said note pad against said base; and
a writing instrument holder for removably holding said writing instrument on said note pad device.

5. The note pad device recited by claim 4 wherein said pad holder is a pair of clips, one said clip being spring loaded and being biased to force one end of said note pad against said base, and the remaining said clip defining a cradle that maintains the remaining end of said note pad in place against said base.

6. The note pad device recited by claim 4 wherein said instrument holder includes a pair of curved, flexible grips that can be forced apart to cradle said instrument between said grips and removably hold said instrument on said note pad holder.

7. The note pad device recited by claim 4 wherein the sheets of said note pad include artwork.
